(19) United States
(12) Patent Application Publication
(10) Pub. No.: US 2024/0169282 A1
(43) Pub. Date: May 23, 2024

(54) AUTOMATED EXTRACTION OF IMPLICIT TASKS

(71) Applicant: Microsoft Technology Licensing, LLC, Redmond, WA (US)

(72) Inventors: Ryen W. WHITE, Woodinville, WA (US); Robert A. SIM, Bellevue, WA (US); Mark ENCARNACIÓN, Bellevue, WA (US); Elnaz NOURI, Redmond, WA (US); Michael GAMON, Bellevue, WA (US); Nalin SINGAL, Kirkland, WA (US)

(73) Assignee: Microsoft Technology Licensing, LLC, Redmond, WA (US)

(21) Appl. No.: 18/425,924

(22) Filed: Jan. 29, 2024

Related U.S. Application Data
(63) Continuation of application No. 16/542,156, filed on Aug. 15, 2019.

(51) Int. Cl. G06Q 10/0631

(52) U.S. Cl. CPC G06Q 10/06311; G06F 40/30

(57) ABSTRACT

Aspects of the present disclosure relate to obtaining task and/or list information from various types of media files. In examples, an image of an environment may be obtained, where the image may include a depiction of a plurality of tasks. The tasks may be extracted from the image and assigned to one or more users based contextual information within the image. In some examples, tasks within an image may be identified based on positional information of the text and/or character delimiters. In some examples, audio information may be received and processed such that the audio information is converted to text. The text may then be parsed to extract one or more items of a list and/or one or more tasks.

### CROSS-REFERENCE TO RELATED APPLICATIONS

This application is a continuation of U.S. patent application Ser. No. 16/542,156, filed on Aug. 15, 2019, the disclosure of which is hereby incorporated by reference in its entirety.

### BACKGROUND

Users that have been assigned tasks at meetings in group settings may have difficulty entering the assigned tasks into a task management application. The task management solution enables users to track various tasks throughout the task lifecycle. While using a task management application sounds like a good solution, many users find that it is not easy to enter tasks into the application when the tasks have been originally recorded in analog form, for example, where tasks may be arranged on whiteboards, recorded on sticky notes, or provided in an audio form.

It is with respect to these and other general considerations that embodiments have been described. Also, although relatively specific problems have been discussed, it should be understood that the embodiments should not be limited to solving the specific problems identified in the background.

### SUMMARY

Examples of the present disclosure describe systems and methods for converting visual and audio-based task lists into machine-readable lists. That is, tasks, or items, that are represented in analog form, such as but not limited to notes, text and/or drawings on a whiteboard, and/or in an audio form, often need to be converted to a digital form to be actionable and shared with others. Thus, a user may upload or otherwise acquire new tasks by taking pictures of a whiteboard, from a meeting camera, or by dictating a list of tasks into a smart speaker or other device for example. Additional media, such as audio with a whiteboard image can provide additional context for the extraction of content and extraction of tasks. Moreover, examples incorporate context from media data, other information (attending parties, meeting dates, other data from various media types), audio listening from a meeting or discussion to proactively add context/items and tasks. Additional context for identifying task assignments includes handwriting styles, facial recognition, voice recognition, writing utensil use and writing medium. In some examples, detailed task descriptions may be inferred given terse, abstract or URL-based input

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates details of a first task extraction system in accordance with the aspects a of the disclosure;

FIG. 2 illustrates details of a second task extraction system in accordance with the aspects a of the disclosure;

FIG. 3 depicts additional details of a component of the task extraction system in accordance with examples of the present disclosure;

FIG. 4 depicts how one or more tasks may be identified from one or more other tasks in accordance with examples of the present disclosure;

FIG. 5 depicts how one or more tasks may be linked to one another in accordance with examples of the present disclosure;

FIG. 6 depicts a text parsing example in accordance with examples of the present disclosure;

FIG. 7 depicts details of a first method in accordance with examples of the present disclosure;

FIG. 8 depicts details of a second method in accordance with examples of the present disclosure;

FIG. 9 depicts details of a second method in accordance with examples of the present disclosure;

FIG. 10 depicts details of a data structure in accordance with examples of the present disclosure;

FIG. 11 depicts additional details of a first graphical user interface in accordance with examples of the present disclosure;

FIG. 12 is a block diagram illustrating example physical components of a computing device with which aspects of the disclosure may be practiced;

FIG. 13A is a simplified block diagram of a computing device with which aspects of the present disclosure may be practiced;

FIG. 13B is another are simplified block diagram of a mobile computing device with which aspects of the present disclosure may be practiced; and

FIG. 14 is a simplified block diagram of a distributed computing system in which aspects of the present disclosure may be practiced.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

A task management application provides functionality that enables a user to manage and track a task to completion. However, some users, and some users in groups, struggle to get the tasks entered into a task management application. For example, to have tasks provided on sticky notes arranged on a whiteboard imported into a task management application, a user would essentially need to transcribe the tasks, assigning the tasks to various users as the information is entered. In accordance with examples of the present disclosure, a task extraction system is provided that extracts tasks from images of an environment. For example, a user may take a picture of a whiteboard that has all tasks arranged in a hierarchical ordering. The task extraction system may identify text associated with each task and then assign the task to one or more users based context within the image. For example, a user's handwriting on a sticky note may be utilized to assign that particular user the specific task. Similarly, audio data may be analyzed, where lists of items, such as tasks, may be extracted and provided to the task extraction system. Accordingly, tasks, or items, that are represented in analog form may be converted, or transitioned, to a digital form or representation such that the tasks, or items, may be actionable and/or shared with others.

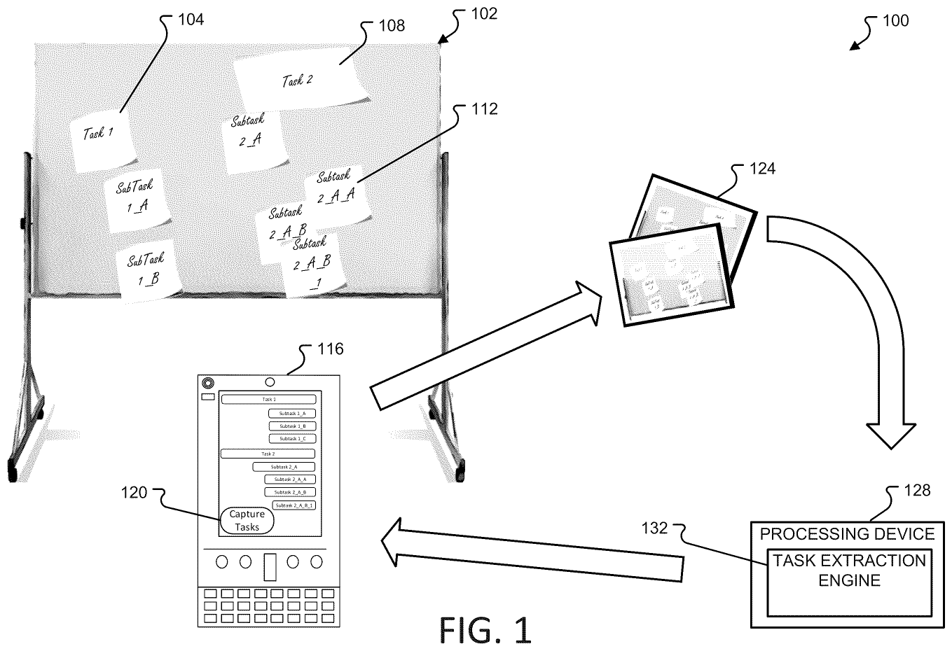

FIG. 1 depicts details of a task extraction system 100 in accordance with examples of the present disclosure. A user, or other entity, utilizing the task extraction system 100 may desire to extract one or more tasks from a source of information in the user's surrounding environment. In some examples, such information may be in analog form. For example, and as depicted in FIG. 1, one or more users may use one or more sticky notes during a planning meeting, or other session to visualize and organize thoughts and concepts. A user may write text on a sticky note and place it on a board, such as the board 102. In some instances, the sticky notes may be arranged as tasks 104/108 and subtasks 112, where a subtask 112 may be one or more steps of a task or otherwise comprise a portion of the general task 108 as illustrated in FIG. 1. To directly capture the information on the sticky notes, a user may photograph or otherwise obtain an image of the layout and arrangement of the sticky notes. For example, a user may utilize a mobile device 116, and more specifically, an application executing on the mobile device 116 to obtain an image of the board 102 and capture and extract the information displayed in the sticky notes utilizing layout and positioning information obtained by the relative positions of each sticky note and/or text on the sticky note. In some instances, the mobile device 116 may include a button 120 or other activation method for activating a camera functionality of the mobile device 116. The image obtained by the mobile device 116 may be processed such that text may be extracted from the image. In some examples, an optical character recognition process is performed on the image such that the text associated with the sticky note is converted from an analog form to a digital form.

Having text information extracted from a sticky note does not automatically convert the text into a task. That is, additional processing must be performed on the image and/or the information extracted from the image in order to identify and generate one or more tasks based on the image and the sticky note. Accordingly, the one or more images 124 acquired from the mobile device 116 may be provided to a processing device 128 that includes a task extraction engine 132. The processing device 128 may correspond to a device including a processor and memory that executes or otherwise runs an application to perform one or more steps as described herein. Accordingly, the processing device 128, and more specifically, the task extraction engine 132, may perform one or more steps to receive the image(s) 124, process or filter the images 124, and further extract one or more tasks as described herein. The tasks may then be presented to a user interface of a computing device, such as the mobile device 116, such that user may review the tasks, edit the tasks, and ensure that the tasks displayed are consistent with the tasks acquired from the image(s) 124.

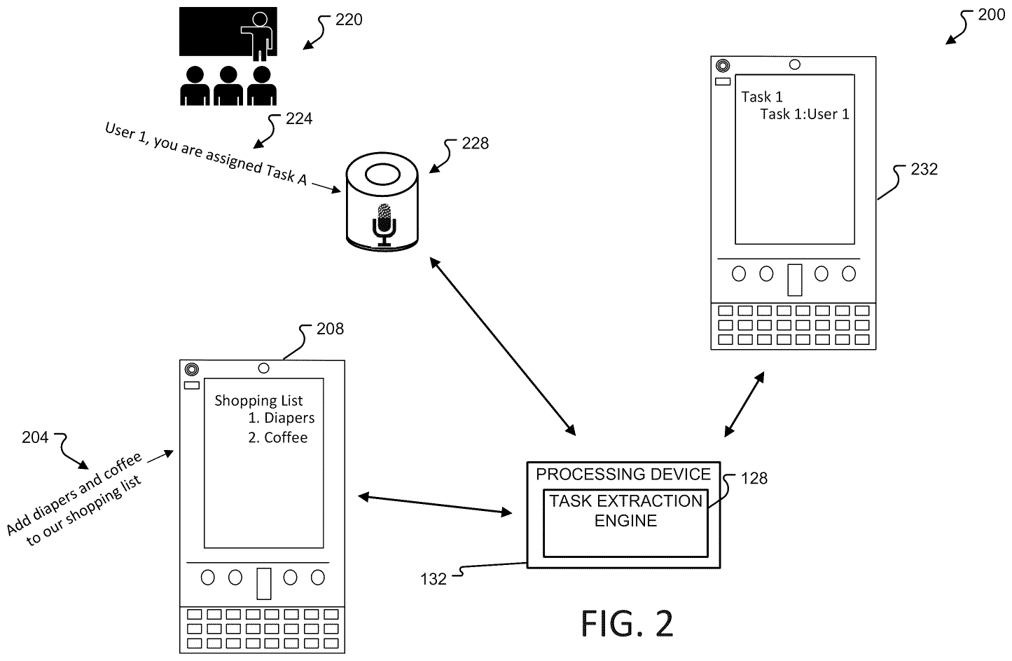

FIG. 2 depicts another example of extracting text from information in accordance with examples of the present disclosure. More specifically, audio information, not having been previously classified, processed, and/or manipulated such that tasks are readily extractable, may be received at the mobile device 208 and/or a smart speaker 228. In some instances, audio information including a single utterance may contain multiple items or tasks. Accordingly, text corresponding to each item or task may be extracted and added to a list as a separate entry. For example, audio information 204 input as “Add diapers and coffee to our shopping list” may be provided to the mobile device 208 such that the separate items of diapers and coffee may be added to a same list. In another example, audio passively acquired from a group of users participating in a meeting 220 may be observed, where the spoken and recovered phrase of “Mary will create a new design” is received at the smart speaker 228. The smart speaker 228 and/or the mobile device 208 may process the audio information and generate text, where the text may distinguish between or otherwise delineate separate items or tasks when included in the audio information. The smart speaker may be any speaker that includes the ability to receive audio information as well as provide audio information. That is, the smart speaker may include a microphone and a speaker and a user may be able to interact with the smart speaker.

Audio information acquired from the smart speaker and/or the mobile device 208 may be converted to text, such as a text transcript. Semantic information providing context to the text may also be included. For example, a semantic focus, such as a comma or pause, after a large word is one type, or form, of semantic marking. Such information may be useful for gaining a greater understanding of what exactly is meant by the received audio information and may help provide meaning to the audio information and text. The processing device 128 may receive the audio information and perform additional audio processing techniques. In some instances, portions of the audio may be converted to text in accordance with one or more audio-to-text characterization processes. In some instances, the processing device 128 may include additional contextual meaning or significance with the text. Based on the audio information, and more specifically, the text from the audio information and/or the meaning of the words within the audio information, one or more tasks may be identified and provided to the processing device 232 and/or back to the mobile device 208. The identified tasks may then be displayed to the user for verification and/or editing.

It should be noted that although the task extraction system 200 has been described with respect to the extraction of one or more tasks from the audio information, the task extraction system 200 may also extract information for the purposes of building one or more lists. Unlike traditional dictation and convert methods, such as when spoken audio information is directly transcribed to a document, the task extraction system 200 may utilize contextual information together with one or more meanings of one or more spoken words to determine that the words should be added as separate independent items to the list. For example, rather than adding “diapers and coffee” as a single entry to a shopping list for instance, the task extraction system 200 may determine that diapers and coffee are separate and distinct items. Thus, coffee may be added to the shopping list and diapers may be added to the shopping list.

A further use of contextual information associated with FIGS. 1 and 2 involves utilizing contextual information to further extract information about who the tasks and/or lists are being generated by and/or assigned to. For example, returning to FIG. 1, if video information is acquired rather than a single image, facial recognition techniques may be applied to determine who wrote on a sticky note and/or an image of an individual to which the sticky note, and therefore tasks, has been assigned. Turning back to FIG. 2, audio identification information may be utilized to identify one or more speakers, or sources of information, and to further associated a task and/or list item with the individual in some manner.

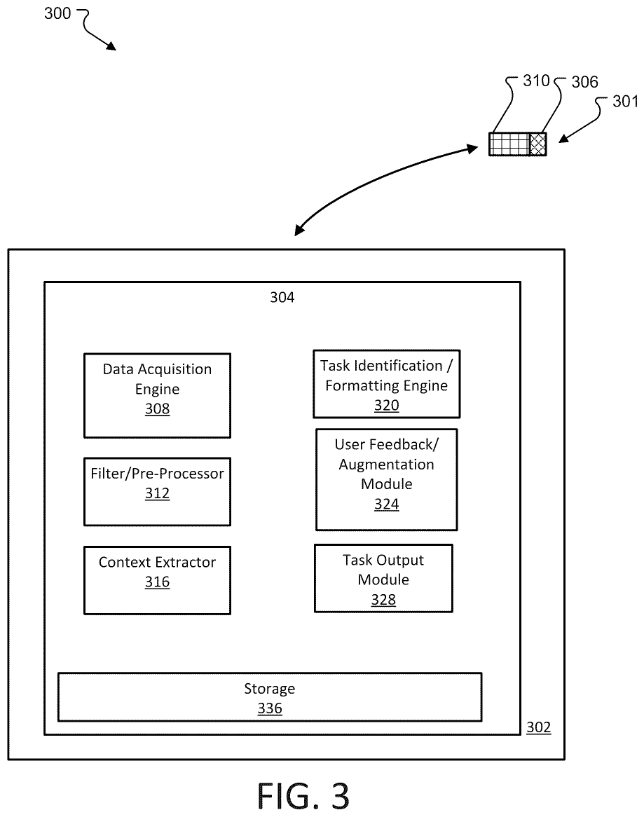

FIG. 3 provides additional details of the task extraction system 300 in accordance with examples of the present disclosure. More specifically, FIG. 3 depicts a processing device 302 that includes a task extraction application 304 which may be the same as or similar to the task extraction systems described with respect to FIG. 1 and FIG. 2. The task extraction system 300 may include the processing device 302, such as a processing device or smart speaker etc. The task extraction application may include a data acquisition engine 308, a filter/pre-processor 312, a context extractor 316, a task identification/formatting engine 320, a user feedback/augmentation module 324, a task output module 328 and a storage area 336.

The task extraction system 300 may receive information 301 for processing. The information 301 may include, but is not limited to, video information, audio information, image information, and stroke information from a stylus or smart whiteboard. The payload information 310 may be transmitted to the processing device 302 and may include header information 306 for identifying the transmitted information and/or payload information 310 containing the data portion of the information 301. The data acquisition engine 308 may receive the information 301 in a variety of ways. For example, the data acquisition engine 308 may receive an image from a camera or otherwise interact with the camera to initiate the acquisition of the image. The data acquisition engine 308 may correspond to a passive listening session at the smart speaker 228 and may acquire audio information in a passive manner. The data acquisition engine 308 may then provide the acquired information to the filter/pre-processor 312. The filter/pre-processor 312 may filter an image utilizing one or more filters, such as but not limited to, a filter for reducing noise within the image. Similarly, an audio filter may be utilized to enhance one or more portions of an audio clip or audio signal. The context extractor 316 may receive the filtered information and may proceed to extract context from the information. For example, the context may correspond to identifies of individuals within the audio clip, video clip, or image, a medium on which one or more tasks where written (for example, a sticky note vs. a whiteboard), time, date, location information as well as an identity of the user. The context extractor 316 may provide the extracted context to the task identification/formatting engine 320. The task identification/formatting engine 320 may extract one or more tasks from the image, from the audio portion, and/or from a video portion. It should further be understood that a task may span multiple media. For example, a task may be extracted from a sticky note but additional details about the task may be included in a video or audio medium. Accordingly, the task extraction system 100 may assembly one or more tasks utilizing various information mediums.

The task extraction application 304 may then provide the extracted tasks to a user for their review and/or editing. In some instances, the extracted tasks may be provided to an output device via the task output module 328, such as a display of a computing device. In other instances, the extracted tasks may be provided as audio output information. A user may then have the ability to review the tasks and make any changes or edits as necessary. The extracted tasks may then be stored in the storage area 336 for later use and retrieval.

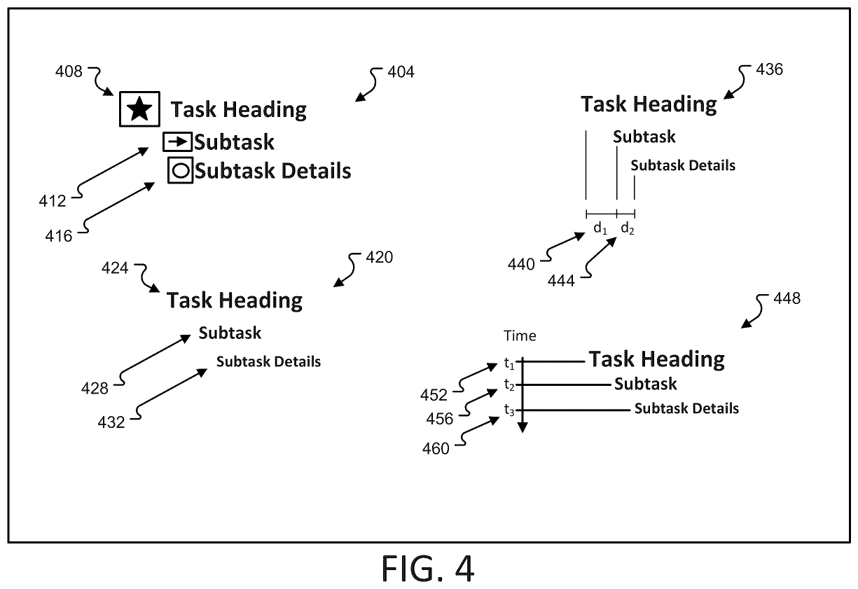

FIG. 4 depicts examples of how one or more tasks may be identified from text written on a sticky note for example. That is, text from one or more sticky notes arranged on a whiteboard for example, may be arranged in a specific pattern or format for identifying a task. In a first example 404, a task may be explicitly identified utilizing one or more marks, graphic elements, or other symbols specific to a level of task. That is, a first level corresponding to a star 408 may identify a task name, header, or other information generally associated with an uppermost or highest hierarchical level for a task. A subtask of the task may be identified utilizing a right arrow 412, and details of the subtask may be identified utilizing a circle 416. As another example, a font and/or size of text may be utilized to distinguish tasks from subtasks and/or subtask details. As depicted in example 420, a larger size text 424 may correspond to the first task, or task level, a medium size text 428 may correspond to the subtask level, and the smallest text size 432 may correspond to the subtask details. As another example, example 436 generally corresponds to an amount of offset, or spacing, each item has with respect to one another. That is, a first amount of offset 440 would generally indicate that the subtask hierarchically belongs to the task above and that the task details are provided via the text having an offset equal to d2 444. Similarly, distinguishing between tasks, subtasks, and/or details of either may be performed chronologically. That is, a user may write a task 452 prior to or otherwise before the subtask 456; while the subtask 456 may be written to or otherwise provided before the subtask details 460 in example 448. Of course, other methods exist for identifying tasks from written information and such examples provided in FIG. 4 should not be considered limiting.

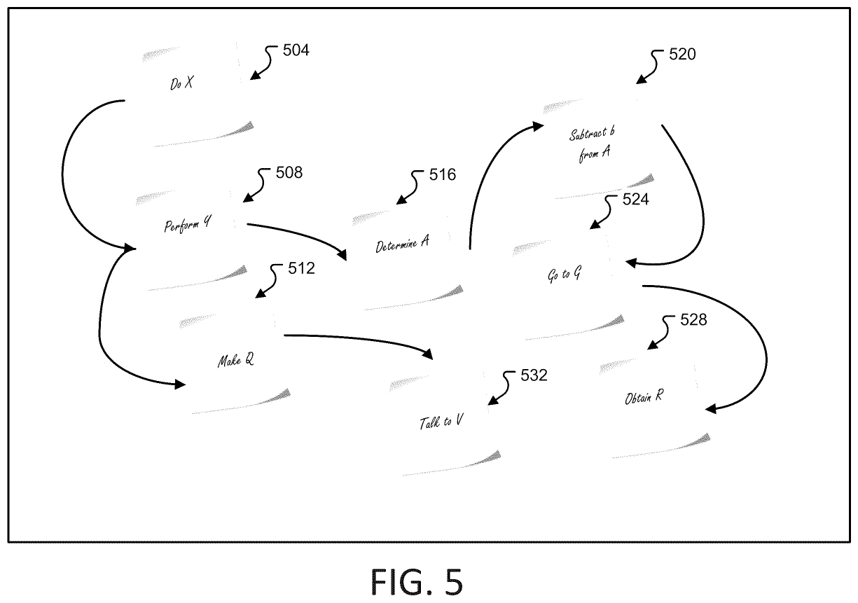

FIG. 5 provides additional details with regard to task and/or subtask linking. In some instances, tasks and/or subtasks may be linked to one another in a specific order. For example, similar to a flowchart, a first task 504 may be required to be complete before task 508 is started, completed, or otherwise initiated. Accordingly, the context extractor 316 and/or the task identification/formatting engine 320 may identify such linking and assemble, or generate, one or more tasks for a user based on the linked tasks. The context extractor 316 and/or the task identification/formatting engine 320 may utilize one or more machine learning techniques to and/or one or more template matching techniques to determine which elements 504-532 may be linked to one another. For example, a user may draw on a whiteboard one or more arrows linking one element to another element, where an element may be the same as or similar to a task. The context extractor 316 and/or the task identification/formatting engine 320 may identify an arrowhead, and/or a line going from one element to another element, thereby creating a relationship between such elements.

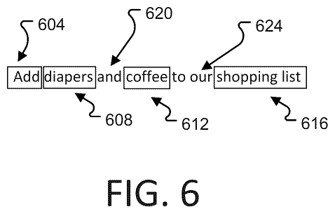

FIG. 6 provides additional details with regard to audio processing and/or task extraction utilizing an audio source as input to the task extraction engine 132. As previously described, the task extraction engine 132 may receive audio, process the audio to enhance one or more audio characteristics, such as but not limited to applying a noise filter, isolating one or more frequencies, and/or adjusting a playback rate. The audio information may then be converted to text resembling the text depicted in FIG. 6. Portions 608 and 612 may be isolated based on one or more trigger words or keywords 604 for example. In some instances, the trigger word and/or key word may be configured ahead of time; in other examples one or more natural language processing techniques may be applied to the text of FIG. 6 to isolate differing parts of speech and extract meaning from the statement. Accordingly, the task extraction engine 132 may determine that the keyword “Add” implies that one or more items are to be added together or added to something. Based on the conjunction 620, the task extraction engine 132 may determine that the two nouns closest to the conjunction are to be joined or are of equal syntactic importance and are to be added to the shopping list 616. In some instances, the task extraction engine 132 may determine that the words “to our” 624 implies ownership and as such may perform further processing to identify a particular user or speaker. For example, a voice fingerprint may be utilized to determine one or more individuals speaking. In some situations, contextual information, such as a location of an acquired audio clip and/or one or more cross referencing techniques where a contextual information of a user, such as a schedule and/or location, is cross-referenced with another item, such location information from a mobile device or the like. Accordingly, a user, or speaker, may be identified and the task extraction engine 132 may extract, or generate, a task to be completed, such as “add diapers and coffee to our shopping list.” Such task may be performed by a third party and/or by one or more components of the task extraction engine 132.

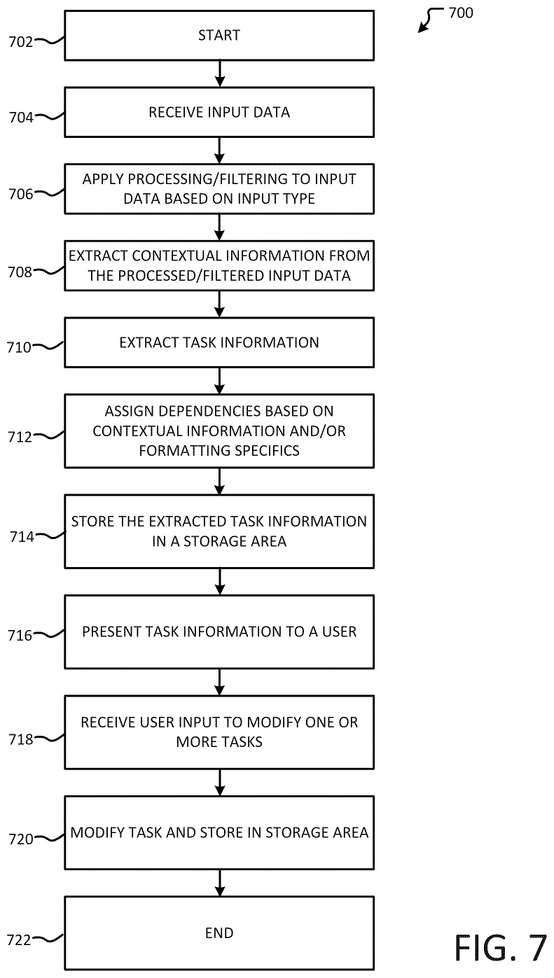

FIG. 7 depicts details of a method 700 for extracting one or more tasks from input information or data. A general order for the steps of the method 700 is shown in FIG. 7. Generally, the method 700 starts with a start operation 702 and ends with the end operation 722. The method 700 may include more or fewer steps or may arrange the order of the steps differently than those shown in FIG. 7. The method 700 can be executed as a set of computer-executable instructions executed by a computer system and encoded or stored on a computer readable medium. Further, the method 700 can be performed by gates or circuits associated with a processor, Application Specific Integrated Circuit (ASIC), a field programmable gate array (FPGA), a system on chip (SOC), or other hardware device. Hereinafter, the method 700 shall be explained with reference to the systems, components, modules, software, data structures, user interfaces, etc. described in conjunction with FIGS. 1-6.

The method 700 starts at 702 and proceeds to 708 where input data is received. As previously discussed, the input data may be video data, audio data, and/or image data. In some examples, the input data may be multimedia data or other data that indicate that one or more tasks are to be extracted. For example, a user may activate a task capture feature on one or more processing devices that records audio, video, and/or records an image for further processing. At 706, the received data may be subjected to filter to enhance one or more areas of data encapsulating or otherwise containing task information. For example, sticky notes arranged on a whiteboard may need additional processing, such as contrast enhancement and/or other image enhancement techniques to increase the contrast of the text on the sticky know with respect to the background of the sticky note. In some instances, an optical character recognition (OCR) technique may be employed to identify text, letters, numbers or the like. Accordingly, when contextual information is extracted at 708, at least a portion of the contextual information may include positions of the text with respect to a media on which the text was written and with respect to other text and other media in the input data. For example, a single sticky note may include two tasks; thus positional information with respect to differing lines of text may be utilized to identify multiple tasks. Further, additional contextual information may be extracted from the image. For example, the contextual information relating to a media type may be obtained and may be utilized in the extraction and generation of the task information and/or to identify one or more users to which the task is to apply. That is, a known individual may utilize one color or type of sticky note while another user may utilize another type of sticky note. Alternatively, or in addition, a first user may write with a first color of ink or writing utensil while a second user may write with a second color of ink or another writing utensil. Accordingly, the contextual information associated with the processed input data may be utilized to not only assist in the identification and/or generation of task related information, but may also be utilized to identify a specific user to which the task was assigned or a specific user that assigned a task. As another example, if the input data is video, a facial recognition technique may be employed to identify as user, determine that the user is speaking, and further determine an individual the user is speaking to. The contextual information of the video may be utilized to determine not only that a task exists, but also the specifics of the task or other parameters of the task.

The method 700 may proceed to 710 where task information is extracted from the input data. In some instances, 710 may be similar to generating task information from specifics included in the processed and/or analyzed input data. That is, together with the contextual information, a task may be generated based on keyword identification techniques, machine learning techniques, and/or other task identification and analysis techniques. In some instances, formatting may be determined based template matching techniques, pattern matching techniques, or the like and may be utilized to identify one or more tasks, and/or additional context of a task. For example, and as discussed with respect of FIG. 4, task and subtask details may be present in the input data and may provide additional information utilized when analyzing context. That is, a specific task may be extracted or generated based on contextual information determined to be in the subtask details. The method 700 may proceed to 712 where dependencies based on contextual information may be assigned. In some instances, the contextual information is formatting information; for example, one element or item identified as a task may be indented below another element or item identified as a task. Thus, a relationship between the two elements may exist. Further, as discussed in FIG. 5, one or more additional or other techniques may be employed to identify if a task is associated with another task. For example, if in an image of tasks on a whiteboard, a line may have been drawing between associated tasks. Thus, dependencies may be assigned.

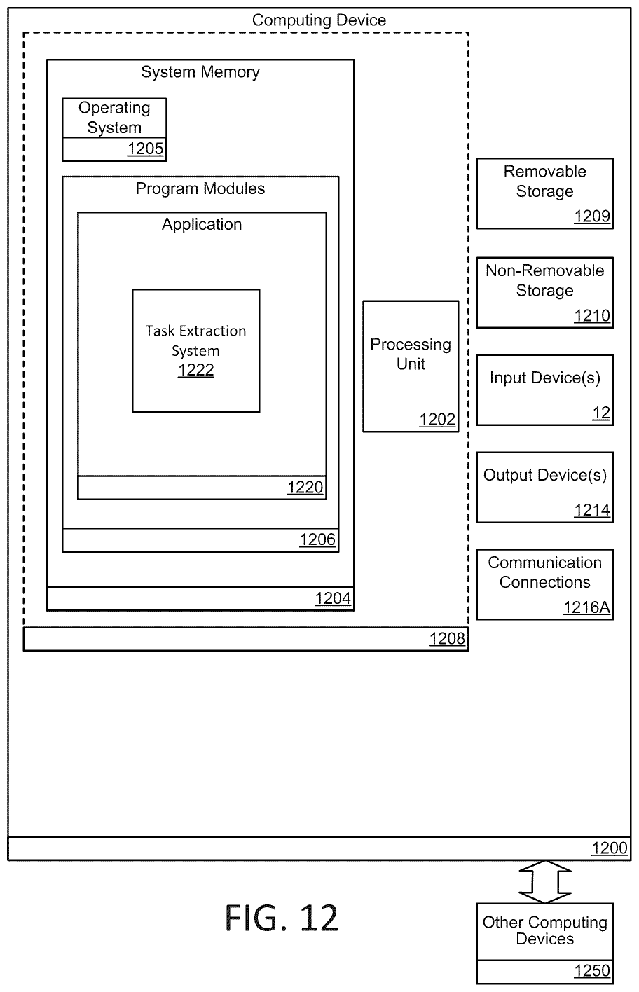

The task information, as well as contextual information, may then be stored at 714. For example, the information may be stored in the storage area 336. In some instances, the tasks that have been extracted may be presented to a user in a graphical user interface at 716. The graphical user interface may be the same as or similar to the graphical user interface of FIG. 12. Thus, a user may be able to interact with the graphical user interface, change a parameter of an identified task, delete a task, assign a hierarchy, and/or modify the task in some manner. The user may then make such modification at 718 and the modifications may be stored in the storage area 336 at 720 for example. The method 700 may then end at 722.

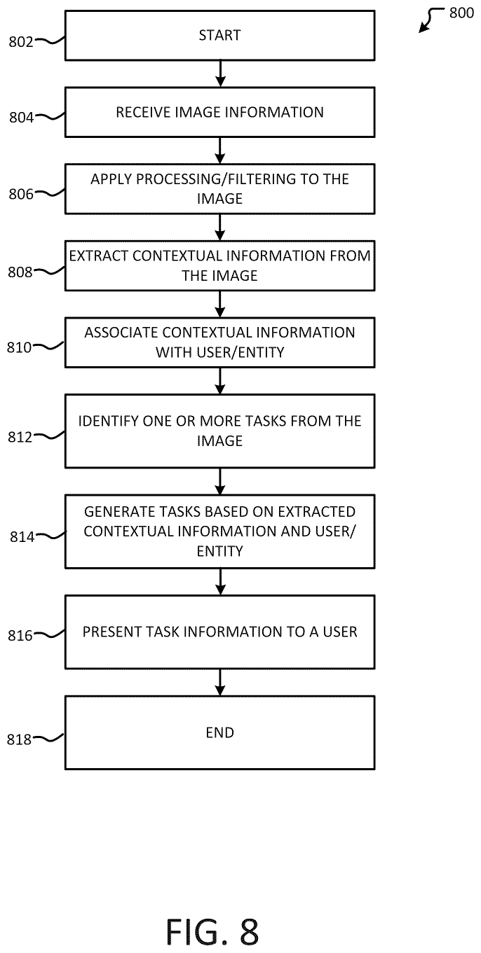

FIG. 8 depicts additional details associated with task extraction and context analysis in accordance with examples of the present disclosure. More specifically, a general order for the steps of the method 800 is shown in FIG. 8. Generally, the method 800 starts with a start operation 802 and ends with the end operation 818. The method 800 may include more or fewer steps or may arrange the order of the steps differently than those shown in FIG. 8. The method 800 can be executed as a set of computer-executable instructions executed by a computer system and encoded or stored on a computer readable medium. Further, the method 800 can be performed by gates or circuits associated with a processor, Application Specific Integrated Circuit (ASIC), a field programmable gate array (FPGA), a system on chip (SOC), or other hardware device. Hereinafter, the method 800 shall be explained with reference to the systems, components, modules, software, data structures, user interfaces, etc. described in conjunction with FIGS. 1-7.

The method 800 starts at 802 and proceeds to 804 where image information may be received. In some examples, image information may be received in response to a user activating a task capture functionality of an application. That is, an application a user is interacting with may include a “capture task” functionality to acquire an image via a camera, the device's camera, or in another manner. At 806, the image may be processed and/or filtered to enhance the ability of task extraction and retrieval process. The method 800 may proceed to 808 where contextual information may be extracted from the image. As previously discussed, the contextual information may correspond to, but is not limited to, a medium on which text is written, a type of medium, a color of ink that is used, a person associated with the image, a person in the image, a positional layout of text in the image, and delineation between different portions of text such that task and subtask identification may be more easily achieved. At 810, contextual information retrieved from the image may be associated with a user and/or other entity. As one example, the contextual information may be associated with a building, a room in a building, an individual, and user account, a user's identify, an user's schedule, and other user information. Such information may be specific to the user (e.g., a user capturing an image of a couple of sticky notes in the user's office) while other information may be associated with or otherwise correspond to multiple people if a large whiteboard meant to be shared.

At 812, one or more tasks may be identified from the image received at 804. More specifically, an OCR process may have been performed on text in the image; in some examples, the positional layout of the text with respect to a medium and other mediums and text determines how one or more tasks are identified from the image. Further, the one or more tasks may be based on the contextual information previously extracted or determined from the image. For example, a user may have been associated with a specific writing utensil that generates a specific color of text. Accordingly, one or more tasks extracted from a medium having that specific color of text may be associated with a user and/or other entity at 814. Accordingly, at 816, the extracted tasks may be presented to a user at a graphical user interface for example. The method 800 may end at 818.

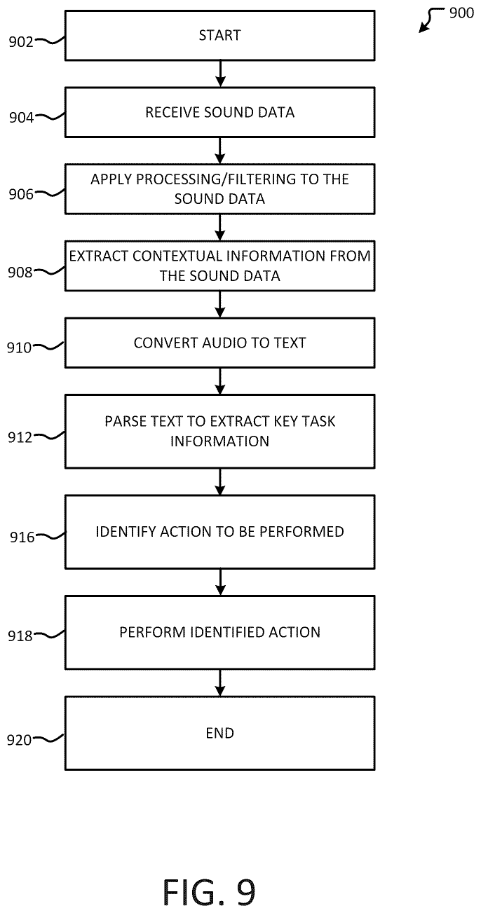

FIG. 9 depicts additional details associated with task extraction and context analysis in accordance with examples of the present disclosure. More specifically, a general order for the steps of the method 900 is shown in FIG. 9. Generally, the method 900 starts with a start operation 902 and ends with the end operation 920. The method 900 may include more or fewer steps or may arrange the order of the steps differently than those shown in FIG. 9. The method 900 can be executed as a set of computer-executable instructions executed by a computer system and encoded or stored on a computer readable medium. Further, the method 900 can be performed by gates or circuits associated with a processor, Application Specific Integrated Circuit (ASIC), a field programmable gate array (FPGA), a system on chip (SOC), or other hardware device. Hereinafter, the method 900 shall be explained with reference to the systems, components, modules, software, data structures, user interfaces, etc. described in conjunction with FIGS. 1-8.

The method 900 starts at 902 and proceeds to 904 where sound information, or sound data, may be received. In some examples, the sound data may correspond to a user creating a memo note or recording themselves speaking into a microphone of their mobile device. At 906 filtering and/or processing may be performed upon the sound data. The filtering and/or processing may remove unwanted noise and/or enhance a specific parameter or characteristic of the sound data. For example, a specific frequency of sound may be most ideal for analysis and removing a tone determined not be contextual information and/or other information may assist the task extraction process. At 908, contextual information from the sound data may be identified and extracted. In some examples, this may correspond to the recorded speech being matched to a user or speaker via voice print or another matching technique. Location information associated with the sound data may also be utilized. In some instances, the sound data may correspond to a voice recording or voice message. The filtered and/or processed sound data may then be converted from audio to text via an audio to text conversion process at 910. At 912, the text may be parsed to identify one or more tasks and/or key tasks within the sound information. In some instances, the tasks within the sound information may correspond to adding items to a list or including a third party or entity for example. At 916, an item or action to be performed may be identified; for example, “add this item and that item to a list.” At 918, the action or otherwise may be performed. For example, a third-party entity may actually perform the action but rely on the identified action of method 900 to identify the action to be performed. The method 900 may circle back to 902 or end at 920.

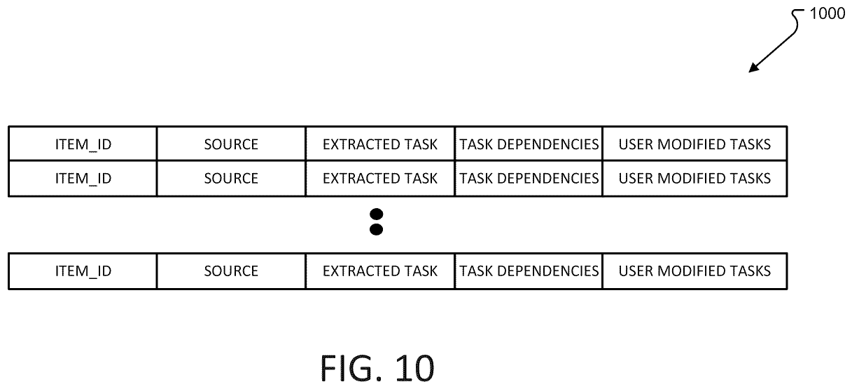

FIG. 10 provides additional details of a data structure in accordance with examples of the present disclosure. More specifically, the data structure may store one or more items utilized to extract one or more tasks. The data structure may store an Item_ID corresponding to a unique entry in a database for task and/or contextual data identification purposes. As another example, the data structure may store a source of the data, such as the image, sound, video file, or link to such source of data. As further illustrated in FIG. 10, the data structure may store the extracted task, either as one or more parameters of an extracted task or as a link to the extracted task. In some instances, one task may depend on another task and/or the other task may depend on the one task. Accordingly, task dependencies may be stored in data structure 1000 such that task execution may be tracked. As previously indicated, a user may modify one or more tasks that were generated for their approval and presented at a graphical user interface. Accordingly, the data structure of FIG. 10 may store these user modified tasks, such that future task extraction operations may reference the user modified tasks to improve task extraction techniques.

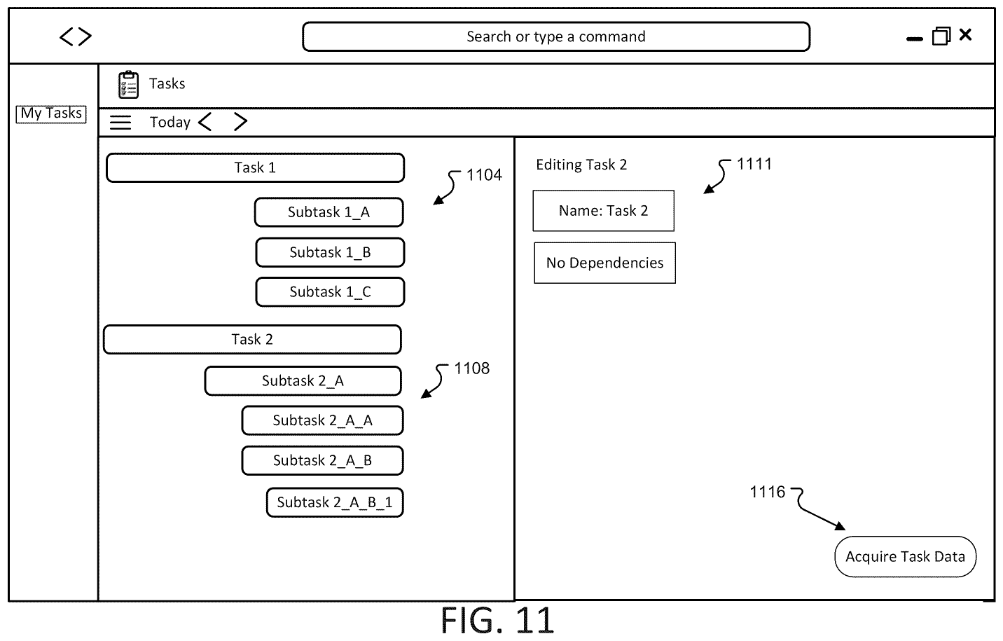

FIG. 11 depicts an example graphical user interface in accordance with examples of the present disclosure. More specifically, the graphical user interface 1100 may display the tasks that were extracted as part of the task extraction process. In some instances, the graphical user interface 1100 may correspond to a task manager application that allows a user to interact with and/or track their progress towards task completion. Thus, for a user to add more tasks, the user may simply select or otherwise activate the button 1116 causing an application associated with the graphical user interface to interact with a camera or microphone for example. As further depicted in FIG. 11, the tasks 1104 and 1108 generally correspond to the tasks discussed with respect to FIG. 2. Thus, the tasks displayed in FIG. 11 correspond to tasks that have been previously extracted. A user may be able to change a task name 1111 and/or other parameters of task.

FIG. 12 is a block diagram illustrating physical components (e.g., hardware) of a computing device 1200 with which aspects of the disclosure may be practiced. The computing device components described below may be suitable for the computing devices, such as the mobile device 116, and/or the processing device 128, as described above. In a basic configuration, the computing device 1200 may include at least one processing unit 1202 and a system memory 1204. Depending on the configuration and type of computing device, the system memory 1204 may comprise, but is not limited to, volatile storage (e.g., random access memory), non-volatile storage (e.g., read-only memory), flash memory, or any combination of such memories. The system memory 1204 may include an operating system 1205 and one or more program modules 1206 suitable for performing the various aspects disclosed herein such as the smart coach system 1201. The operating system 1205, for example, may be suitable for controlling the operation of the computing device 1200. Furthermore, aspects of the disclosure may be practiced in conjunction with a graphics library, other operating systems, or any other application program and is not limited to any particular application or system. This basic configuration is illustrated in FIG. 12 by those components within a dashed line 1208. The computing device 1200 may have additional features or functionality. For example, the computing device 1200 may also include additional data storage devices (removable and/or non-removable) such as, for example, magnetic disks, optical disks, or tape. Such additional storage is illustrated in FIG. 12 by a removable storage device 1209 and a non-removable storage device 1210.

As stated above, a number of program modules and data files may be stored in the system memory 1204. While executing on the processing unit 1202, the program modules 1206 (e.g., one or more applications 1220/12222) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1200 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1200 may also have one or more input device(s) 1212 such as a keyboard, a mouse, a pen, a sound or voice input device, a touch or swipe input device, etc. The output device(s) 1214 such as a display, speakers, a printer, etc. may also be included. The aforementioned devices are examples and others may be used. The computing device 1200 may include one or more communication connections 1216A allowing communications with other computing devices 1250. Examples of suitable communication connections 1216A include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1204, the removable storage device 1209, and the non-removable storage device 1210 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1200. Any such computer storage media may be part of the computing device 1200. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

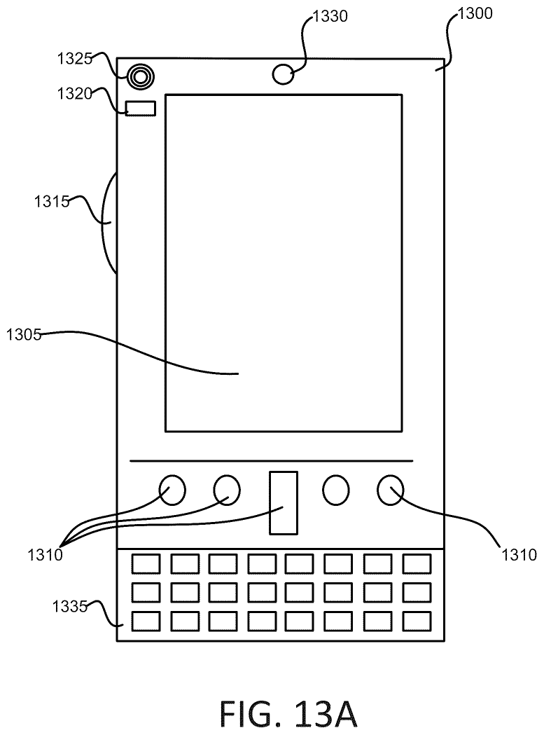

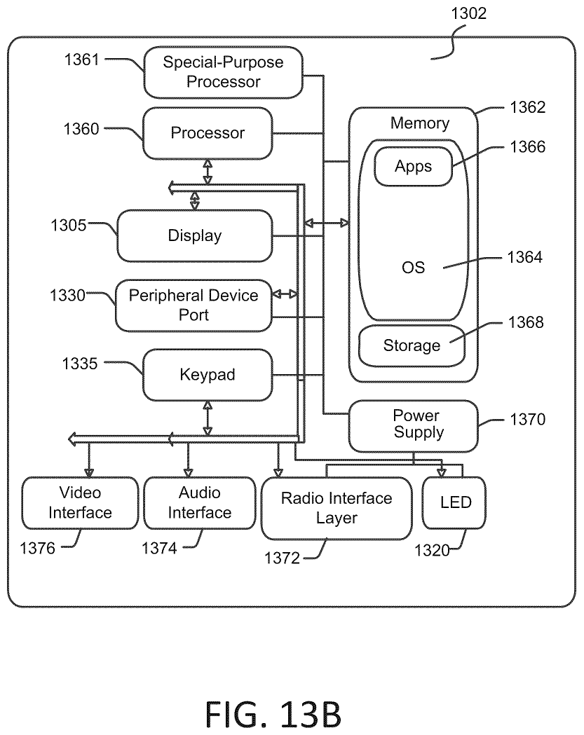

FIGS. 13A and 13B illustrate a computing device, client device, or mobile computing device 1400, for example, a mobile telephone, a smart phone, wearable computer (such as a smart watch), a tablet computer, a laptop computer, and the like, with which aspects of the disclosure may be practiced. In some aspects, the client device (e.g., 116) may be a mobile computing device. With reference to FIG. 13A, one aspect of a mobile computing device 1300 for implementing the aspects is illustrated. In a basic configuration, the mobile computing device 1300 is a handheld computer having both input elements and output elements. The mobile computing device 1300 typically includes a display 1305 and one or more input buttons 1310 that allow the user to enter information into the mobile computing device 1300. The display 1305 of the mobile computing device 1300 may also function as an input device (e.g., a touch screen display). If included, an optional side input element 1315 allows further user input. The side input element 1315 may be a rotary switch, a button, or any other type of manual input element. In alternative aspects, mobile computing device 1300 may incorporate more or less input elements. For example, the display 1305 may not be a touch screen in some aspects. In yet another alternative aspect, the mobile computing device 1300 is a portable phone system, such as a cellular phone. The mobile computing device 1300 may also include an optional keypad 1335. Optional keypad 1335 may be a physical keypad or a “soft” keypad generated on the touch screen display. In various aspects, the output elements include the display 1305 for showing a graphical user interface (GUI), a visual indicator 1320 (e.g., a light emitting diode), and/or an audio transducer 1325 (e.g., a speaker). In some aspects, the mobile computing device 1300 incorporates a vibration transducer for providing the user with tactile feedback. In yet another aspect, the mobile computing device 1300 incorporates input and/or output ports, such as an audio input (e.g., a microphone jack), an audio output (e.g., a headphone jack), and a video output (e.g., a HDMI port) for sending signals to or receiving signals from an external source.

FIG. 13B is a block diagram illustrating the architecture of one aspect of computing device, a server, or a mobile computing device. That is, the computing device 1300 can incorporate a system (e.g., an architecture) 1302 to implement some aspects. The system 1302 can implemented as a “smart phone” capable of running one or more applications (e.g., browser, e-mail, calendaring, contact managers, messaging clients, games, and media clients/players). In some aspects, the system 1302 is integrated as a computing device, such as an integrated personal digital assistant (PDA) and wireless phone.

One or more application programs 1366 may be loaded into the memory 1362 and run on or in association with the operating system 1364. Examples of the application programs include phone dialer programs, one or more components of the smart coach systems, e-mail programs, personal information management (PIM) programs, word processing programs, spreadsheet programs, Internet browser programs, messaging programs, and so forth. The system 1302 also includes a non-volatile storage area 1368 within the memory 1362. The non-volatile storage area 1368 may be used to store persistent information that should not be lost if the system 1302 is powered down. The application programs 1366 may use and store information in the non-volatile storage area 1368, such as e-mail or other messages used by an e-mail application, title content, and the like. A synchronization application (not shown) also resides on the system 1302 and is programmed to interact with a corresponding synchronization application resident on a host computer to keep the information stored in the non-volatile storage area 1368 synchronized with corresponding information stored at the host computer. As should be appreciated, other applications may be loaded into the memory 1362 and run on the mobile computing device 1300 described herein (e.g., search engine, extractor module, relevancy ranking module, answer scoring module, etc.).

The system 1302 has a power supply 1370, which may be implemented as one or more batteries. The power supply 1370 might further include an external power source, such as an AC adapter or a powered docking cradle that supplements or recharges the batteries.

The system 1302 may also include a radio interface layer 1372 that performs the function of transmitting and receiving radio frequency communications. The radio interface layer 1372 facilitates wireless connectivity between the system 1302 and the “outside world,” via a communications carrier or service provider. Transmissions to and from the radio interface layer 1372 are conducted under control of the operating system 1364. In other words, communications received by the radio interface layer 1372 may be disseminated to the application programs 1366 via the operating system 1364, and vice versa.

The visual indicator 1320 may be used to provide visual notifications, and/or an audio interface 1374 may be used for producing audible notifications via the audio transducer 1325. In the illustrated configuration, the visual indicator 1320 is a light emitting diode (LED) and the audio transducer 1325 is a speaker. These devices may be directly coupled to the power supply 1370 so that when activated, they remain on for a duration dictated by the notification mechanism even though the processor 1360 and other components might shut down for conserving battery power. The LED may be programmed to remain on indefinitely until the user takes action to indicate the powered-on status of the device. The audio interface 1374 is used to provide audible signals to and receive audible signals from the user. For example, in addition to being coupled to the audio transducer 1325, the audio interface 1374 may also be coupled to a microphone to receive audible input, such as to facilitate a telephone conversation. In accordance with aspects of the present disclosure, the microphone may also serve as an audio sensor to facilitate control of notifications, as will be described below. The system 1302 may further include a video interface 1376 that enables an operation of an on-board camera 1330 to record still images, video stream, and the like.

A mobile computing device 1300 implementing the system 1302 may have additional features or functionality. For example, the mobile computing device 1300 may also include additional data storage devices (removable and/or non-removable) such as, magnetic disks, optical disks, or tape. Such additional storage is illustrated in FIG. 13B by the non-volatile storage area 1368.

Data/information generated or captured by the mobile computing device 1300 and stored via the system 1302 may be stored locally on the mobile computing device 1300, as described above, or the data may be stored on any number of storage media that may be accessed by the device via the radio interface layer 1372 or via a wired connection between the mobile computing device 1300 and a separate computing device associated with the mobile computing device 1300, for example, a server computer in a distributed computing network, such as the Internet. As should be appreciated such data/information may be accessed via the mobile computing device 1300 via the radio interface layer 1372 or via a distributed computing network. Similarly, such data/information may be readily transferred between computing devices for storage and use according to well-known data/information transfer and storage means, including electronic mail and collaborative data/information sharing systems.

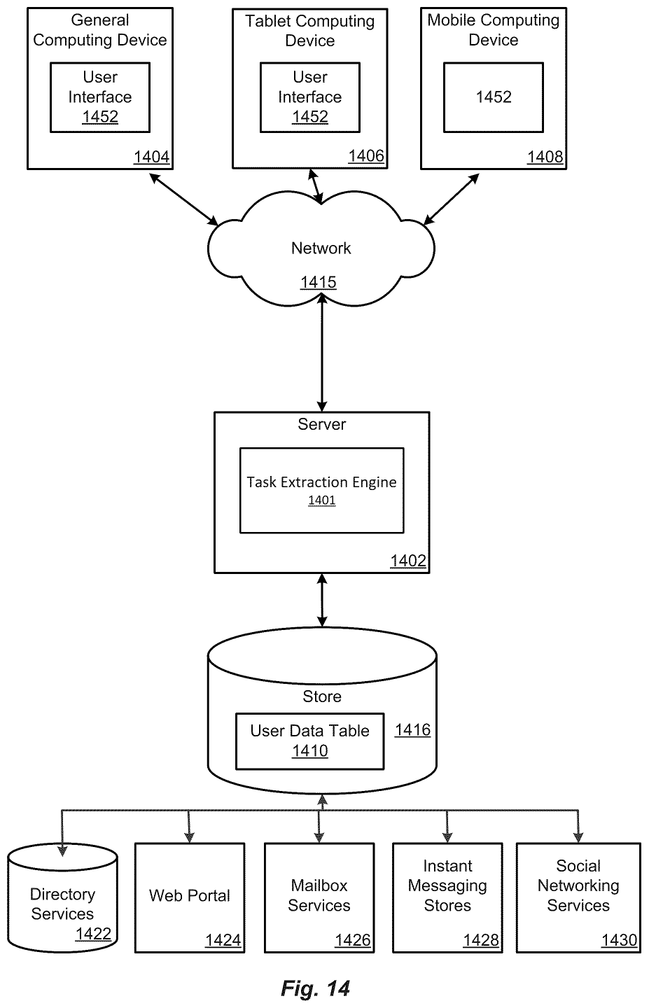

FIG. 14 illustrates one aspect of the architecture of a system for processing data received at task extraction engine 1401 from a remote source, as described above. Content at a server device 1402 may be stored in different communication channels or other storage types. For example, various images, or files may be stored using a directory service 1422, a web portal 1424, a mailbox service 1426, an instant messaging store 1428, or a social networking site 1430. A unified profile API based on the user data table 1410 may be employed by a client that communicates with server device 1402. The server device 1402 may provide data to and from a client computing device such as the mobile device 116 through a network 1415. By way of example, the mobile device 116 described above may be embodied in a personal computer 1404, a tablet computing device 1406, and/or a mobile computing device 1408 (e.g., a smart phone).

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

In accordance with examples of the present disclosure, a system is provided. The system includes at least one processor and memory storing instructions that, when executed by the at least one processor, causes the system to perform a set of operations, the set of operations including extracting contextual information from input data associated with a list of items, based on the extracted contextual information, analyzing the input data and identifying at least one item of the list of items associated with the contextual information, and identifying a user associated with the contextual information, wherein the user is assigned to the identified at least one item. At least one aspect of the above system may include where the input data is an image depicting a plurality of tasks and subtasks, and the set of operations further include extracting a task depicted in the image, determining a characteristic from contextual information associated with the task, and identifying the user based on the characteristic. At least one aspect of the above system may include where the set of operations further includes causing to be displayed at a user interface, the plurality of tasks and subtasks, receiving a modification to one or more tasks of the plurality of tasks, and storing the modification to the one or more tasks of the plurality of tasks in a storage area. At least one aspect of the above system includes where the input data includes audio data, and wherein the set of operations further includes extracting contextual information from the audio data, based on the extracted contextual information from the audio data, identifying the at least one item of the list of items associated with the contextual information, and assigning the at least one item to the user based on the extracted contextual data from the audio data. At least one aspect of the above system includes where the list of items includes one or more tasks assigned to a user. At least one aspect of the above system includes where the list of items includes a plurality of voice memos. At least one aspect of the above system includes acquiring an image of an environment of the user, determining if the acquired image includes one or more tasks, and extracting one or more tasks for the user based on the acquired image.

In accordance with examples of the present disclosure, a method for extracting a task from an image is provided. The method may include receiving, at a processing device, an image depicting a plurality of tasks and subtasks, extracting a task of the plurality of tasks and subtasks from the image, extracting contextual information from the image, the contextual information being associated with the extracted task, and identifying a user associated with the contextual information, wherein the user is assigned to the task. At least one aspect of the above method includes causing to be displayed at a user interface, the plurality of tasks and subtasks, receiving a modification to one or more tasks of the plurality of tasks, and storing the modification to the one or more tasks of the plurality of tasks in a storage area. At least one aspect of the above method includes receiving, at the processing device, audio data, extracting contextual information from the audio data, based on the extracted contextual information from the audio data, identifying the task, and assigning the task to the user based on the extracted contextual information from the audio data. At least one aspect of the above method includes where the contextual information includes text positioning information relative to other text. At least one aspect of the above method includes where the image is an image of an environment of the user, and the method further includes extracting a plurality of tasks for the user based on the received image. At least one aspect of the above method includes extracting text from the image, the text having been made accessible via an optical character recognition process, obtaining text positioning information from the image, and extracting the task based on the text extracted from the image and the text positioning information.

In accordance with at least one example of the present disclosure, a method for extracting task information from an image is provided. The method may include receiving, at a processing device, an image depicting a plurality of tasks and subtasks, performing an optical character recognition process on the image, extracting text from the image, the text having been made accessible via the optical character recognition process, obtaining text positioning information from the image, and generating a task based on the text extracted from the image and the text positioning information. At least one aspect of the above method may include causing to be displayed at a user interface, the plurality of tasks and subtasks, receiving a modification to one or more tasks of the plurality of tasks, and storing the modification to the one or more tasks of the plurality of tasks in a storage area. At least one aspect of the above method may include extracting contextual information from the image, and assigning the task to a user based on the extracted contextual information. At least one aspect of the above method may include identifying a user associated with the contextual information, wherein the user is assigned to the task. At least one aspect of the above method may include determining if the image includes one or more tasks, extracting first and second delineators from the image, the first and second delineators indicating that text associated with the first and second delineators is a task and/or subtask, generating a first task based one the first delineator, and generating a first subtask of the task based on the second delineator. At least one aspect of the above method includes where the text positioning information includes identifying a character delineating a task from other text information in the image. At least one aspect of the above method includes where the image is a first frame of a video, and the text positioning information is based on a placement of text over time.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce a configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
extracting contextual information from input data associated with a list of items;
based on the extracted contextual information, analyzing the input data and identifying at least one item of the list of items associated with the contextual information; and
identifying a user associated with the contextual information, wherein the user is assigned to the identified at least one item.

2. The system of claim 1, wherein the input data is an image depicting a plurality of tasks and subtasks, and the set of operations further comprises:
extracting a task depicted in the image;
determining a characteristic from contextual information associated with the task; and
identifying the user based on the characteristic.

3. The system of claim 2, wherein the set of operations further comprises:
causing to be displayed at a user interface, the plurality of tasks and subtasks;
receiving a modification to one or more tasks of the plurality of tasks; and
storing the modification to the one or more tasks of the plurality of tasks in a storage area.

4. The system of claim 2, wherein the input data includes audio data, and wherein the set of operations further comprises:
extracting contextual information from the audio data;
based on the extracted contextual information from the audio data, identifying the at least one item of the list of items associated with the contextual information; and
assigning the at least one item to the user based on the extracted contextual data from the audio data.

5. The system of claim 2, wherein the list of items includes one or more tasks assigned to a user.

6. The system of claim 2, wherein the list of items includes a plurality of voice memos.

7. The system of claim 1, wherein the set of operations further comprises:
acquiring an image of an environment of the user;
determining if the acquired image includes one or more tasks; and
extracting one or more tasks for the user based on the acquired image.

8. A method for extracting a task from an image, the method including:
receiving, at a processing device, an image depicting a plurality of tasks and subtasks;
extracting a task of the plurality of tasks and subtasks from the image;
extracting contextual information from the image, the contextual information being associated with the extracted task; and
identifying a user associated with the contextual information, wherein the user is assigned to the task.

9. The method of claim 8, further comprising:
causing to be displayed at a user interface, the plurality of tasks and subtasks;
receiving a modification to one or more tasks of the plurality of tasks; and
storing the modification to the one or more tasks of the plurality of tasks in a storage area.

10. The method of claim 8, further comprising:
receiving, at the processing device, audio data;
extracting contextual information from the audio data;
based on the extracted contextual information from the audio data, identifying the task; and
assigning the task to the user based on the extracted contextual information from the audio data.

11. The method of claim 8, wherein the contextual information includes text positioning information relative to other text.

12. The method of claim 8, wherein the image is an image of an environment of the user, the method further comprising:
extracting a plurality of tasks for the user based on the received image.

13. The method of claim 12, further comprising:
extracting text from the image, the text having been made accessible via an optical character recognition process;
obtaining text positioning information from the image; and
extracting the task based on the text extracted from the image and the text positioning information.

14. A method for extracting task information from an image, the method including:
receiving, at a processing device, an image depicting a plurality of tasks and subtasks;
performing an optical character recognition process on the image;
extracting text from the image, the text having been made accessible via the optical character recognition process;
obtaining text positioning information from the image; and
generating a task based on the text extracted from the image and the text positioning information.

15. The method of claim 14, further comprising:
causing to be displayed at a user interface, the plurality of tasks and subtasks;
receiving a modification to one or more tasks of the plurality of tasks; and
storing the modification to the one or more tasks of the plurality of tasks in a storage area.

16. The method of claim 14, further comprising:
extracting contextual information from the image; and
assigning the task to a user based on the extracted contextual information.

17. The method of claim 16, further comprising:
identifying a user associated with the contextual information, wherein the user is assigned to the task.

18. The method of claim 14, further comprising:
determining if the image includes one or more tasks;
extracting first and second delineators from the image, the first and second delineators indicating that text associated with the first and second delineators is a task and/or subtask;
generating a first task based one the first delineator; and
generating a first subtask of the task based on the second delineator.

19. The method of claim 14, wherein the text positioning information includes identifying a character delineating a task from other text information in the image.

20. The method of claim 14, wherein the image is a first frame of a video, and the text positioning information is based on a placement of text over time.
